(19) United States
(12) Patent Application Publication
(10) Pub. No.: US 2006/0242018 A1
(43) Pub. Date: Oct. 26, 2006

(54) Apparatus, system and business method for managing digital media rental subscriber bases

(76) Inventors: Nathan Shulman, Austin, TX (US); Kevin R. Imes, Austin, TX (US)

Correspondence Address: Kevin R. Imes, 2001 So. Mopac #624, Austin, TX, 78746, US

(21) Appl. No.: 11/408,703

(22) Filed: Apr. 21, 2006

Related U.S. Application Data
(60) Provisional application No. 60/673,450, filed on Apr. 21, 2005.

(51) Int. Cl. G06Q 30/00

(52) U.S. Cl. 705/14

(57) ABSTRACT

A business method includes the steps of providing a referral advertisement for a digital media subscription and receiving a request to subscribe in association with the referral advertisement. The method further includes receiving a request to distribute a promotional item operable to store a subscriber-based deliverable to a digital media subscriber and determining a delivery mode to deliver the promotional item. The method also includes communicating a confirmation of the subscription to a referring site, the confirmation provided in association with distributing the promotional item and distributing the promotional item using the confirmation to the digital media subscriber.

### CROSS REFERENCE TO RELATED APPLICATION

This application claims priority to United States Provisional Patent Application entitled “Apparatus and Method for Storing Mail-Based DVD Rentals” having application Ser. No. 60/673,450 and filed on Apr. 21, 2005.

### FIELD OF THE DISCLOSURE

The present invention relates to distribution of digital media and more particular to, an apparatus, system and business method for managing digital media rental subscriber bases.

### BACKGROUND

The digital media rental industry has expanded greatly in recent years due to it's no-hassle nature. For example, a consumer may select a list of digital media to have sent to them from anywhere in the world by accessing an on-line digital media rental portal or website. One or more types of digital media, such as digital videos, games, music, digital books, etc. may be offered through the rental website and distributed to a subscriber for use and return. Some online video rental companies allow individuals to rent an unlimited number of digital video discs (DVDs) or movies as they can view within a month without having to pay any late fees or shipping. Subscription rates typically vary in both price and number of videos that may be out at a given time. For example, an introductory subscription level of $9.99 may allow a consumer to check out only one digital video or game at a time. Other programs allow individuals to check out up to three or more videos or games at any given time. However, renting multiple movies at a single time can lead to mishandling of return envelopes or DVDs. For example, multiple mailings of several digital videos or games can leave a subscriber with having to keep track of return envelopes and informational inserts for the rented videos or games.

Another common problem that exists within the current digital media rental industry is the turn over rate of digital media subscribers. For example, a metric currently employed by the digital media rental industry to measure turn over is called the churn rate. The churn rate is basically a comparison of the total number of subscriptions to the number of cancellations over a specific period of time. It is desirable for digital media rental companies to maintain a low churn rate. However, various dynamics can impact or drive a churn rate resulting increased or decreased rates. For example, an increase in advertising may increase the number of new subscriptions which can lead to an increase in the overall total number of subscriptions. An increase in the overall total number of subscriptions may result in a decrease in the churn rate. However, such advertising may have little or no effect on cancellations. For example, cancellation rates may be effected by various inherent characteristics or internal business methods, processes and policies employed by a digital media rental company which can effect how a company interacts with their current subscriber base. Such internal business methods may contribute to decrease retention rates for company. In some instances, even if an increase in the number of new subscriptions increases as a result of an advertising campaign, loosing current or existing subscribers can erode the new subscriber base which can lead to an overall increase in churn rates. As such, what is needed are business methods and solutions to manage subscriber bases for digital media rental companies.

### SUMMARY OF THE DISCLOSURE

In one form, a business method includes the steps of receiving a request to distribute a promotional item operable to store an order fulfillment article provided in association with a digital media to a digital media subscriber and determining a delivery mode to deliver the promotional item. The method further includes initiating distribution of the promotional item in association with the digital media to the digital media subscriber.

In another form, a business method includes the steps of determining a subscriber characteristic of a digital media subscriber and determining if a promotional item should be delivered to the digital media subscriber based on the subscriber characteristic. The method further includes distributing the promotional item in association with a subscriber-based deliverable to the digital media subscriber.

In an exemplary form, a business method includes the steps of providing a referral advertisement for a digital media subscription and receiving a request to subscribe in association with the referral advertisement. The method further includes receiving a request to distribute a promotional item operable to store a subscriber-based deliverable to a digital media subscriber and determining a delivery mode to deliver the promotional item. The method also includes communicating a confirmation of the subscription to a referring site, the confirmation provided in association with distributing the promotional item and distributing the promotional item using the confirmation to the digital media subscriber.

It is an object of the disclosure to provide promtional items to impact subsciber bases within the digital media rental industry.

It is another object of the disclosure to provide a media organizer that conforms to existing business processes for organizing rented digital media

It is an object of the invention to implement and manage subscriber based quality and marketing systems.

It is a further object of the disclosure to correleate customer feedback to subscription acquisition trends to influence products, services and promotional item offerings.

It is another object of the disclosure to model customer-centric data to enable digital media rental companies to effectively find and market potential customers and measure the effectiveness of marketing campaigns and promotional offers.

It is a further object of the disclosure to provide marketing solutions that target digital media rental subscription activities using tangible mediums or promotional goods aligned with a specific digital media rental company.

It is another object of the invention to provide product and service offerings as a result of correlating business characterstics or subscriber-based profile information to trends in business activites of a digital media rental company.

It is another object of the invention to generate customized promotional offerings that impact churn rates within the digital media rental industry.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a business method for providing promotional items within a digital media rental industry according to one aspect of the invention;

FIG. 2 illustrates a business method for providing promotional items within a digital media rental industry using a third party referral source according to one aspect of the invention;

FIG. 3 illustrates a promotional item for storing rented digital media according to one aspect of the invention;

FIG. 4 illustrates a compact version of a promotional item for storing rented digital media according to one aspect of the invention;

FIG. 5 illustrates order fulfillment articles provided in association with rented digital media according to one aspect of the invention;

FIG. 6 illustrates several embodiments of promotional items for use in a digital media rental industry according to one aspect of the invention;

FIG. 7 illustrates a business system and method for a managing subscribers for digital media rental company according to one aspect of the invention;

FIG. 8 illustrates a business method for providing and monitoring distribution of promotional items in association with customer service calls according to one aspect of the invention;

FIG. 9 illustrates a business method for providing promotional items in association with a customer retention program according to one aspect of the invention; and

FIG. 10 illustrates a business method for providing a subscriber based referral program using promotional items according to one aspect of the invention.

### DETAILED DESCRIPTION

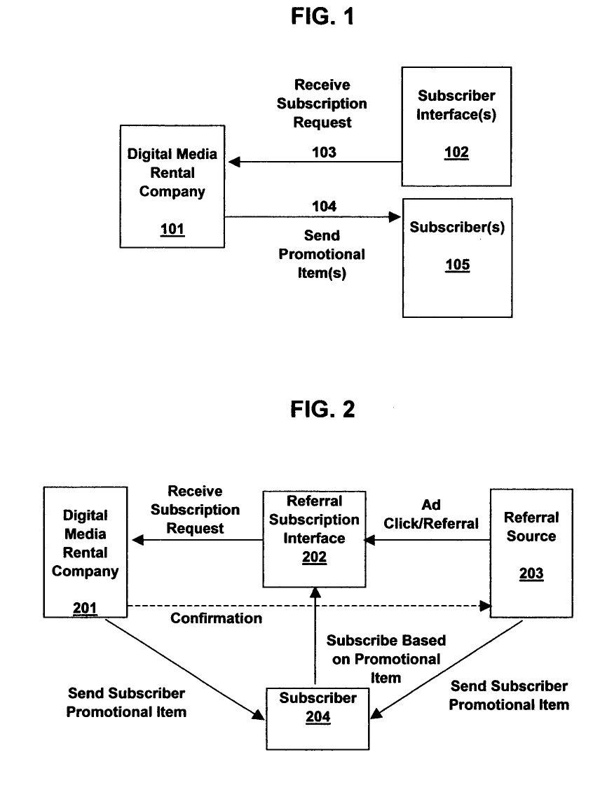

Advantageous embodiments of the disclosure are illustrated in FIGS. 1-9. The embodiments below relate to business processes and systems effecting digital media subscriptions for on-line digital media rental organizations. Various embodiments provided describe the business of impacting new subscriber rates while maintaining an existing subscriber base through providing targeted promotional items. In one form, the business method includes determining one or more metrics, subscriber characteristics, or subscriber profile information from various business units or processes that quantifying subscriber-based information to assist with making various business decisions. The business methods, processes, systems, and apparatuses described below may be employed, in whole or in part, by digital media rental organizations having various internal or external business organizations or affiliates that may benefit from the various embodiments described herein in support of performing business within the digital media rental industry.

FIG. 1 illustrates a business method for providing promotional items within a digital media rental industry according to one aspect of the invention. A subscriber interface 102 is provided by a digital media rental company 101 in an on-line environment and allows for media rental company 101 to receive a subscription request 103 from one or more subscribers. For example, digital media rental company 101 may present a subscriber interface 102 that offers one or more programs or subscription levels for renting digital media including offering monthly fee based subscriptions, one-time use subscriptions, annual subscriptions, or various other types of subscriptions. Subscriber interface 102 may also include an on-line rental portal similar to Netflix® allowing a consumer to select various types of media to rent using various types of rental programs or subscription levels. Subscriber interface 102 may further allow a user to preview movie clips, setup rental lists, read movie and game reviews, post reviews, etc. In one form, digital media rental company 101 provides subscriber interface 102 based on logic that monitors rental activities of a subscriber and offers rental suggestions. In another form, a subscriber profile may be maintained by digital media rental company 101 and may include information specific to a subscriber. Digital media rental company 101 may then determine product or rental offering for a subscriber, and in some instances, may present a similar user interface to or subscribers having similar profile information.

Upon digital media rental company 101 receiving a subscription request 103, digital media rental company 101 sends a promotional item 104 to a subscriber 105 at a reduced fee or free of charge. For example, a digital media rental company 101 may offer a promotional item as a part of or in association with a deliverable that is distributed to a subscriber. For example, for each new subscription, digital media rental company 101 initiates delivery of a promotional item 104 subscriber 105. Various types of promotional items may be provided in association with a deliverable. For example, a promotional item may include a digital media organizer for organizing and storing various items or deliverables distributed to a digital media subscriber. A digital media organizer may be provided for storing and protecting rented DVDs or video games and associated description information, rental slips, return envelopes, or advertisements for new or upcoming releases. In one form, digital media rental company 101 may distribute a future distribution list detailing a list of pre-selected videos or games selected by subscriber 105 and staged to be mailed. This allows subscriber to review their pre-selected movie list without having to access an on-line website. In one embodiment, digital media rental company 101 may include a trailer DVD, coming attractions DVD, or other form of digital media within a digital media organizer to reduce costs associated with mailing a digital media organizer. Additionally, cost for digital media organizer may be offset cost of through establishing relations with movie studios for sending promotional videos, trailers, upcoming attractions, etc. In one form, software or games may also be mailed with a digital media organizer. As such, a promotional item may include a digital media organizer for storing and organizing rented digital media and associated information. In this manner, digital media rental company 101 may protect rented digital media while building customer loyalty through offering a free promotional item. As such, an increased subscription or retention interval for subscriber(s) 105 may be realized thereby reducing turn over rates for digital media rental company 101.

Other forms of promotional items may also be distributed in association with a deliverable to subscriber(s) 105 to build customer loyalty. For example, a promotional item may include coupons for receiving discounts at various on-line retailers, customer loyalty cards for affiliates, one or more free rental months, movie tickets for local theaters, trailers or preview DVDs, promotional video games, loyalty or reward points, coupons for selecting a free used DVD from digital media rental company 101 or an affiliate that is managing inventory of used DVDs, movie trivia cards, crossword puzzles or other printed games, or any other type of promotional item that may build customer loyalty to extend a subscription interval of a subscriber.

In one embodiment, subscriber(s) 105 may access subscriber interface(s) 104 to update a subscription level for receiving rented digital media For example, a user may upgrade to a program that allows a subscriber to receive unlimited rentals. Additionally, a subscriber may not have previously received a promotional item for a subscription or may have already received a certain type of promotional item. As such, digital media rental company 101 may access a subscriber profile having a promotional distribution information and initiate distribution of a promotional item in response to a subscriber upgrading to a new level. In this manner, various types of promotional items may be provided to subscribers based on their subscription level. In another embodiment, as a subscriber's subscription expires or is close to expiring, digital media rental company 101 may access a subscriber profile and determine when a subscription is set to expire and initiate distributing a promotional item to subscriber 105 prior to expiration in an effort to maintain customer loyalty. In one embodiment, digital media rental company 101 may automatically renew the subscription and send a promotional item to the subscriber after renewing their subscription.

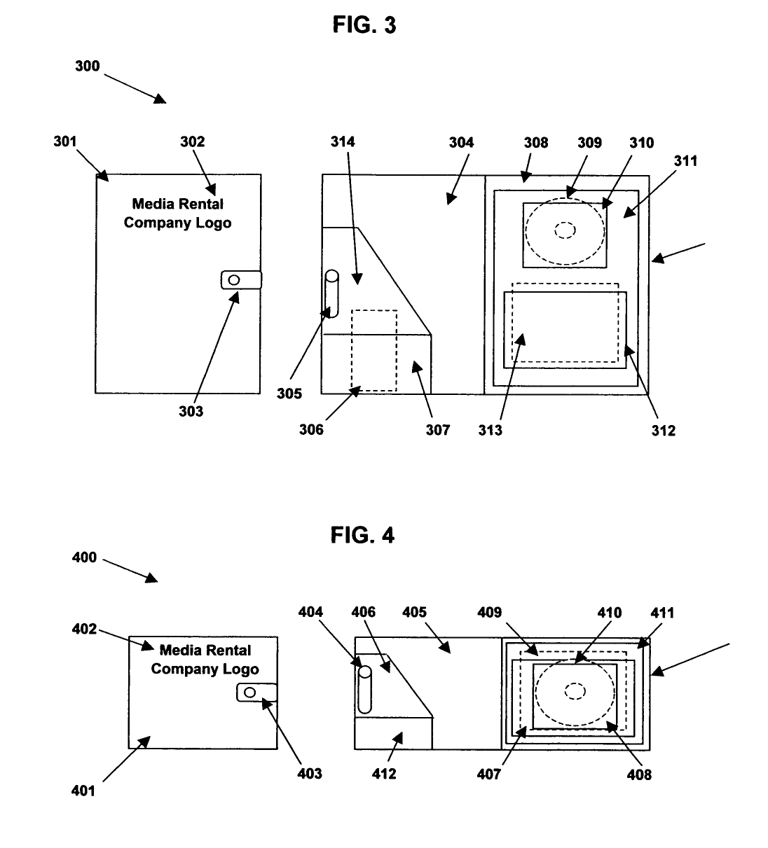

FIG. 2 illustrates a business method for providing promotional items within a digital media rental industry using a third party referral source according to one aspect of the invention. A digital media rental company 201 may directly or indirectly provide a promotional item in association with a referral program to a subscriber 204. For example, a referral source 203 may receive a request for a subscription using an advertisement or promotion posted by referral source 203 and a new subscriber may be directed to a referral subscription interface 202 using an ‘Ad Click’ advertisement or other form of referral link. A new subscriber may be redirected from a referral source's website via a referral subscription interface 202 to digital media rental company 201. Digital media rental company 201 may then receive a subscription request from a new subscriber and send a subscription conformation referral source 203 crediting referral source 203 with the new subscription. For example, digital media rental company 201 may pay referral source 203 a fixed referral fee (e.g. fifteen dollars, twenty dollars, etc.) for each referral provided by referral source 203. In one embodiment, in addition to paying a referral fee or in lieu of paying the referral fee, digital media rental company 201 may distribute a promotional item to subscriber 204 that was previously purchased from referral source 203. For example, digital media rental company 201 may purchase an inventory of promotional items from referral source 203 and referral source 203 may direct referrals to media rental site 201 by advertising the promotional item in association with subscribing to media service company 201. For each referral provided by referral source 203, digital media rental company 201 may send a new subscriber 204 a promotional item and may also provide a referral fee or other type of compensation to referral source 203. In this manner, referral source 201 may market a promotional item may be marketed in association with digital media rental company 201 to increase subscriptions.

In one embodiment, digital media rental company 201 may send a confirmation to referral source 203 that a subscription has been received and referral source 203 may then distribute a promotional item to subscriber 204. Digital media rental company 201 may provide offer a referral fee to referral source 203 and an address for subscriber 204 to enable distribution a promotional item to subscriber 204 from a third party referral source. In this manner, a referral source 203 may market a promotional item in association with a new subscription initiated and digital media rental company 201 may pay a referral payment to referral source 203 may distribute the promotional item to subscriber 204. In this manner, a media rental company need not keep an inventory of promotional items provided in association with a referral.

In another embodiment, referral source 203 may send a promotional item directly to subscriber 204 in association with selling a promotional item directly to a subscriber that may already have a subscription. In another form, referral source 203 and/or digital media rental company 201 may target bargain hunting websites (e.g. Dealnews, Techbargains) or gadget weblogs (e.g. Gizmodo) to sell a promotional item in association with obtaining rental service from digital media rental company 201. For example, a consumer may purchase a promotional item at a discount from referral source 203 and receive one or more months of free service from digital media rental company 201. A coupon, referral designator or card, or other item that may uniquely identify referral source 203 and allowing a consumer to rent digital media on a trial basis. If a consumer extends the trial period by one or more months, digital media rental company 201 may provide a referral fee or a portion of the future rental proceeds to referral source 203.

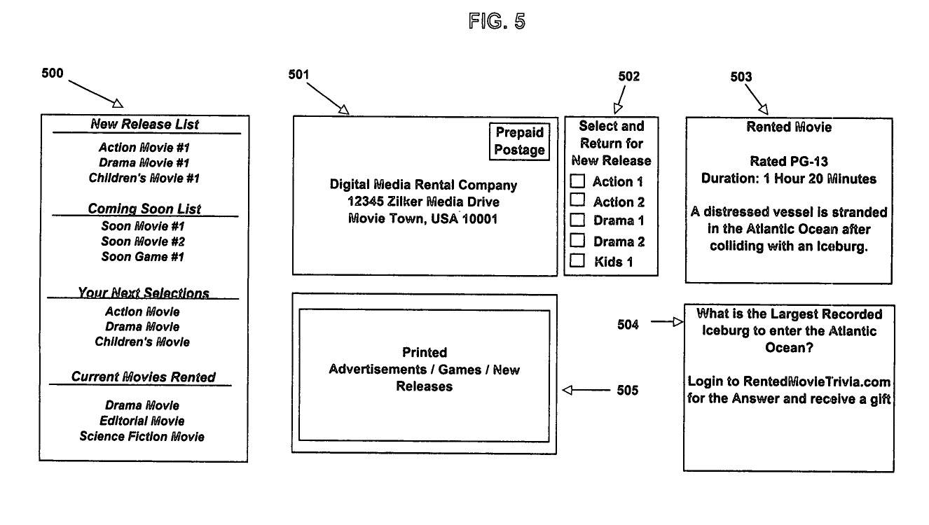

FIG. 3 illustrates one embodiment of a promotional item for storing rented digital media according to one aspect of the invention. A promotional item, illustrated as a media rental organizer 300, includes a cover 302 having a media rental company logo 302 and a fastener 303 such as a snap, hook and loop material, etc. for holding media rental organizer 300 in a closed position. Other types of information other than, or instead of, media rental company logo 302 may be printed on media rental organizer 300. For example, media rental organizer 300 may be co-branded with a digital media rental company, an media rental organizer manufacturer, movie or game production studios, or various other types of advertising. The overall cost for selling or distributing media rental organizer 300 may be offset by selling advertising that may be printed on a portion of media rental organizer 300. In another form, media rental organizer may include a ‘movie poster’ printed on media rental organizer 300. For example, media rental organizer 300 may be left within a home theater and as such may be displayed on a coffee table, etc. having a specific type of movie poster. In this manner, a visitor may find media rental organizer 300 to be appealing and may inquire with an owner as to where they obtained media rental organizer 300. A subscriber may then refer the visitor to the media rental company that provided media rental organizer 300 to subscribe to the rental service and obtain a media rental organizer 300.

Media rental organizer 300 includes high quality materials, such as Koskin, a leatherette, or various other quality materials. Media rental organizer 300 further includes an internal front cover 304 having a first sleeve portion 314 for storing return envelopes (not expressly shown) and second sleeve portion 307 for storing additional rental information, promotional items such as coupons, movie tickets, etc. Media rental organizer 300 further includes a pen holder 305 for securely storing a writing utensil such as a pen or pencil. Media rental organizer 300 further includes an internal back cover 308 having a substantially similar configuration as internal front cover 304.

Media rental organizer 300 further includes a media divider 311 including a digital media storage sleeve 310 sized to securely store digital media 309 such as a DVD, video game, music, audio books, etc. Media divider 311 includes a semitransparent material along media divider 311 to allow a user to view a title for digital media 309 without removing digital media 309 from digital media storage sleeve 310. Digital media storage sleeve 310 further includes a rear portion lined with a fabric material for protecting digital media 309. Media divider 311 further includes a digital media description sleeve 312 for storing a descriptor 313 provided by a digital media rental company in association with digital media 309. For example, descriptor 313 may include a printed summary of the contents of digital media 309 such as rating information, a brief description such as a movie, actors, actresses, producers, soundtrack information, game descriptions, book descriptions, music descriptions, release information, or any other type of information that may be unique to digital media 309 stored within digital media storage sleeve 310. Digital media description sleeve 312 is sized larger than digital media storage sleeve 310 however in other embodiments, digital media description sleeve 312 may be sized similar to digital media storage sleeve 310. Media divider 311 further includes a rear portion (not expressly shown) having the same arrangement including a digital media storage sleeve 310 and a digital media description sleeve 312 thereby allowing for storage of two rented digital media discs using the same media divider. Additionally, media divider 311 is securely fastened or bound between front cover 301 and rear cover 308 in a similar manner as a book allowing for browsing of rented digital media. Digital media organizer 300 also includes several media dividers 311 for storing several rented digital media within the same digital media organizer thereby allowing for organizing and managing rented digital media. Digital media organizer 300 includes substantially flat surfaces and includes padding along front cover 301 and rear cover 315 for safely storing digital media 309. Digital media organizer 300 is a portable organizer that may be placed within various locations of a home and may be used to transport digital media 309 and associated description information, return envelopes, etc. to another location for using digital media 309.

During use, a subscriber may receive a subscriber-based deliverable, such as a video, game, etc. and any associated items such as return envelopes, descriptors, coupons, etc. from a digital media rental company. A subscriber stores digital media 309 within separate digital media storage sleeves 310 and places each associated descriptor within a descriptor storage sleeve 312 provided under digital media storage sleeve 310. Return envelopes may be placed within first sleeve portion 314 provided along inside front cover 304 or within a sleeve provided along internal rear cover 308. Any additional items, such as a printout of future rentals, new releases, envelopes, rental contracts, promotional items such as movie tickets, discount coupons, customer referral coupons, etc. may be stored within first sleeve portion 314 or second sleeve portion 307. In one embodiment, other promotional items such as games, crossword puzzles, movie trivia cards, etc. provided by a digital media rental company in an effort to promote customer loyalty may also be stored. Upon a subscriber using the rented digital media, a user may remove digital media 309 from digital media sleeve 310 and media descriptor 313 from media descriptor sleeve 312 and return digital media 309 using a return envelope stored within digital media organizer 300. In this manner, rented digital media, associated description information, return envelopes, and any other type of information and promotional items associated with rented digital media may be organized and stored within a single organizer. As a result, a digital media rental company may realize a reduction in damage to digital media and a reduction in replacing lost return envelopes. An overall reduction in customer service and quality issues surrounding safe handling of digital media and mailings may be realized thereby reducing the overall cost associated with operating a digital media rental company ensured while promoting customer loyalty amongst a digital media subscriber base.

A residual benefit of providing a media organizer 300 as a promotional item may include dilating turn over times for mailed videos. For example, digital media organizer 300 maintains rented videos and associated return envelopes out of sight. As such, a user may be less likely to view and/or return videos in an expeditious manner to having digital media and associated information out of site. For example, a subscriber may watch DVDs less frequently because there are no return envelopes and DVDs scattered throughout a subscriber's house. As such, a subscriber would not have the clutter or disorganization of rented DVDs to remind a subscriber that a DVD needs watched and mailed back to a digital media rental company. As such, digital media rental companies may benefit through not having to mail as many DVDs in a single month thereby reducing the overall cost associated with distributing digital media to subscribers and increasing profits for an existing subscriber base.

FIG. 4 illustrates a compact version of a promotional item for storing rented digital media according to one aspect of the invention. A promotional item, illustrated as a compact media rental organizer 400, includes a front cover 401 having a media rental company logo 402 and a fastener 403 such as a snap, hook and loop material, etc. for holding compact media rental organizer 400 in a closed position. Compact digital media organizer 400 may be secured using a zipper provided along a portion of a perimeter of a front cover 405 and a rear cover 413 for securely opening and closing compact digital media organizer 400. Various other coupling mechanisms may be used as needed. Compact media rental organizer 400 further includes an internal front cover 405 having a first sleeve portion 406 for storing return envelopes (not expressly shown) and second sleeve portion 412 for storing additional rental information, promotional items such as coupons, movie tickets, etc. Compact media rental organizer 400 further includes a pen holder 404 for securely storing a writing utensil such as a pen or pencil. Media rental organizer 300 further includes an internal back cover 413 having substantially the same configuration as internal front cover 405.

Compact digital media organizer 400 further includes a compact media divider 411 for storing a single digital media 410 within digital media storage sleeve 408. Compact media divider 411 further includes a descriptor storage sleeve 407 located behind digital media storage sleeve 408 and sized slightly larger than digital media storage sleeve 408 to allow for insertion of a digital media descriptor 409. Compact media divider 411 includes a rear portion (not expressly shown) having the same configuration thereby allowing for storage of a second rented digital media along a rear portion of compact media divider 411. Compact digital media organizer 400 further includes a series of compact media dividers 411 that are bound between front cover 405 and rear cover 413 allowing for organization of several rented digital media. Compact digital media organizer 400 allows for safe transport and organization of rented digital media and associated return envelopes, descriptors, promotional items, etc. In one form, compact digital media organizer 400 may include a rigid or semi-rigid material to provide additional protection of contents.

Compact digital media organizer 400 is suitable for travel and allows a subscriber to conveniently transport rented DVDs from one point to another allow for convenient viewing of movies in various locations. For example, user may transport DVDs using compact digital media organizer 400 and view DVDs using a portable DVD viewer, a laptop within a vehicle, etc. DVDs may also be safely transported to a friend or relative's house and description information may be reviewed prior to selecting a DVD to watch. If a subscriber is traveling, a subscriber may use return envelopes stored within digital media organizer 400 to mail digital media 410 back to rental company while traveling. In one embodiment, compact media organizer 400 may include an elongated sleeve that extends from front cover 401 to back cover 413 similar appearance to a portion of a conventional wallet having a paper currency holder. In another form, a slot may be provided along an external portion of compact media organizer 400 to store articles that may not fit within compact media organizer. For example, return envelopes may be stored in a compartment outside of compact media organizer 400.

FIG. 5 illustrates order fulfillment articles provided in association with rented digital media according to one aspect of the invention. Each article may be distributed with rented digital media and assists a subscriber with managing rented digital media. A status sheet 500 may be provided to indicate which movies have been currently checked out or rented. A reference to upcoming movies may also be provided to inform a subscriber of the next movies that will be mailed. Status sheet 500 may also include a new release list detailing movies that are now available and a coming soon list detailing what movies will soon be available. A release date may also be provided for each soon to be released movie. In one embodiment, status sheet 500 may be customized based on profile information for a subscriber. For example, digital media rental company may provide a preferred list of new releases and coming soon movies based on a rental history or other data unique to the subscriber.

A prepaid return envelope 501 is also provided and includes an address to a processing center for returning digital media. A perforated tab 502 may be provided to allow a subscriber to select a movie to be sent. For example, a subscriber may see a new release that is not currently on the list of movies to be sent next. Instead of accessing a rental website, a subscriber may simply select one a movie to be mailed next using perforated tab 502. In this manner, a user need not have access to the internet to select or modify distribution of media. Prepaid return envelope 501 further includes a rear portion or disposable flap portion 505 that may include a removable advertisement, game, or new release list. In one form, coupons or other promotional items may be provided. For example, a digital media organizer, such as organizers 300 or 400 may be promoted as a free gift or at a discount for a referral provided by a subscriber. Directions on how to redeem the coupon may also be printed on flap portion 505.

A media descriptor 503 is provided for each digital media sent to a subscriber. Media descriptor 503 may include ratings information, duration, and a short description of the contents of the media. Rear portion 504 of descriptor may also include movie trivia information and a reference for a subscriber to win a promotional item or gift if they answer the question correctly. A user identification for the subscriber may be required to participate in the contest.

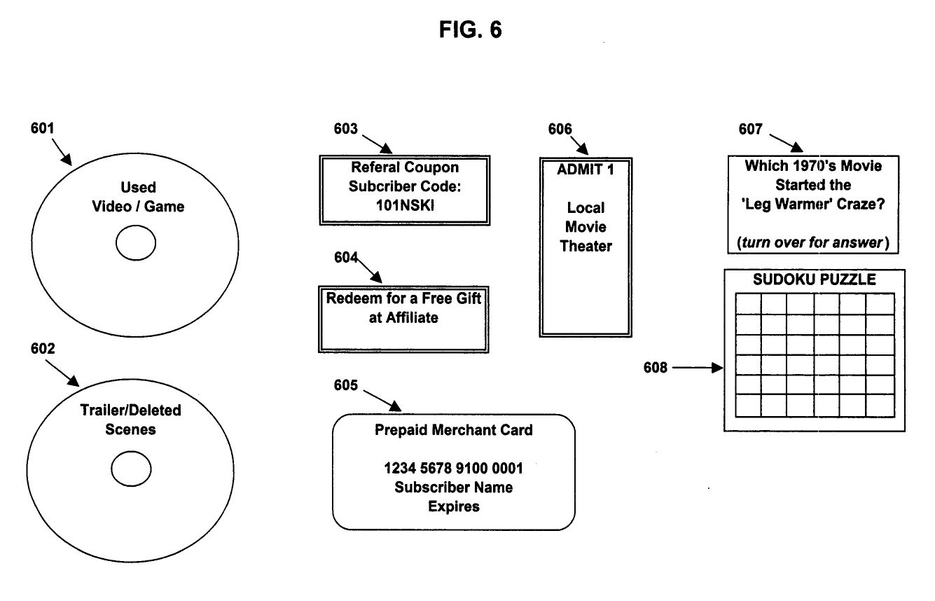

FIG. 6 illustrates several embodiments of promotional items for use in a digital media rental industry according to one aspect of the invention. Various embodiments of promotional items are provided which may be distributed to a subscriber. Promotional items may include a used video or game 601, trailer or deleted scenes 602, a referral coupon 603 having a subscriber code for crediting a subscriber with a referral, a free gift coupon 604 for receiving a free gift from an on-line or retail affiliate, a movie ticket 606 for admission to a local theater, a prepaid merchant card or gift card 605 to allow a user to purchase goods or services, one or more movie trivia cards 607 for playing trivia games with friends and family, and a puzzle 608 such as a crossword puzzle or number game such as Sudoku. Various other promotional items may also be distributed to subscribers.

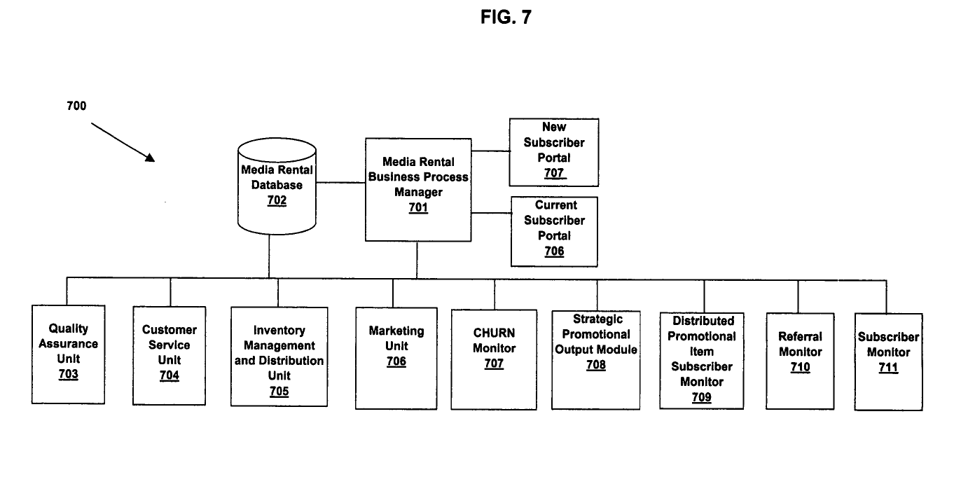

FIG. 7 illustrates a business system and method for a managing subscribers for digital media rental company according to one aspect of the invention. A business systems and method, illustrated generally at 700, include media rental business process manager 701 coupled to a media rental database 702 operable to aggregate data used to manage subscriptions and business activities for a digital media rental company. Although illustrated as a single database, it should be understood that an arrangement disparate databases or data sources either internal or external to a digital media rental company, may be used within system 700. Additionally, the modules, processes, units, and interfaces described below may be provided from a variety of sources, affiliates, service providers, etc. in association with a digital media rental company performing business. Media rental database 702 may also maintain marketing materials for generating a new subscriber portal 707. Business system 700 further includes a current subscriber portal 706 provided by media rental business processes manager 701 that presents data maintained by media rental database 702. A user may access current subscriber portal 706 to read reviews, select digital media, see previews, purchase goods or services, or various other activities. A user may also access a current subscriber portal 706 to purchase items that may be offered through an on-line store provided in association with business system 700. For example, new DVDs, video games, etc. may be offered to a subscriber. In another form, a targeted promotional item may be offered for purchase for a current subscriber or new subscriber. For example, business system 700 may present a media organizer to a new or current subscriber to allow a consumer to purchase the media organizer to store rented digital media. In one form, business system 700 may present media organizer for a third party to targeted consumers such as digital media rental subscribers allowing targeted consumers to purchase a media organizer.

In one form, a subscriber may also access current subscriber portal 706 to modify a subscription level (e.g. increase or decrease monthly rentals) or cancel a subscription. Media rental database 702 maintains profile information for a specific subscriber and may include general subscriber information such as age, sex, location, etc. Subscriber profile information may also include specific subscription-based information such as how long a subscriber has been a customer, the number of customer service related incidences a subscriber has had over a given period, the number of referrals a subscriber has provided, the number and type of promotional item(s) a subscriber may have received, whether the subscriber transferred from another media rental company, the average number of movies a subscriber watches in a month, the return dates and days for returning digital media.

Business system 700 further includes a quality assurance unit 703 operable to manage quality issues for a digital media rental company and a customer service unit 704 operable to handle consumer or subscriber issues that may present themselves during the course of performing business within the digital media rental industry. Customer service unit 704 may be co-located with the main business units of a digital media rental company or may be subcontracted to a third party to manage customer service calls. Business system 700 further includes an inventory management and distribution unit 705 operable to manage inventory of digital media, mailings, acquisition of new digital media such as new releases, disposition of used or damaged digital media. In one form, inventory management and distribution unit 705 may further manage acquisition and distribution of promotional items for subscribers.

Business system 700 further includes a marketing unit 706 that provides marketing for a digital media rental company. Marketing unit 706 may be provided internal and/or external to a digital media rental company and provides marketing strategies that affect a digital media rental company employing business system 700. In one embodiment, marketing unit 706 performs market tasks including deploying marketing strategies, performing market research, determining an impact of a marketing strategy, performing future and present customer surveys, observing customer interactions with a digital media rental company, analyzing subscriber profile information and demographics, formulating a promotional item campaign, formulating referral programs for affiliates and subscribers, or various other functions or processes that may be provided as input to business system 700. Marketing unit 700 may also provide customer-centric data modeling to enable a digital media rental company to effectively find and market to potential customers and measure the effectiveness of marketing campaigns for a digital media rental company.

Business unit 707 further includes a CHURN monitor 707 operable to monitor a churn rate for a digital media rental company. A churn rate determined by observing the number of new subscribers, the number of cancellations and the total number of subscribers within a subscriber base. A churn rate may further be adjusted based on free subscriptions or other promotions that may influence a churn rate.

Business system 700 further includes a strategic promotional item output module 708 that provides promotional business strategies that targets digital media rental subscribers. Strategic promotional output module 708 may access media rental database 702 to formulate a strategic promotional item offering through providing tangible mediums or promotional goods aligned with a specific subscriber within the digital media rental industry. For example, strategic promotion output module 708 may receive inputs from one or more sources internal or external to business system 700 to determine a promotional product offering. In one form, strategic promotional output module 708 may generate a promotional item offering for a group or subgroup of subscribers or potential customers by correlating or modeling customer feedback provided from, for example, quality assurance unit 703, customer service unit 704, and marketing unit 706 to generate a customized promotional offering to impact a churn rate monitored by CHURN monitor 707. In this manner, strategic promotional output module 708 may blend customer feedback and subscription acquisition trends into promotional product offerings to create a tactile or loyal subscriber base. May also maintain reward points for a subscriber.

Business system 700 further includes a distributed promotional item subscriber monitor 709 that monitors activities of a subscriber that has received a promotional item. For example, some activities may include a determining if a subscriber maintains an uninterrupted subscription, whether a subscriber calls in with a customer service issue, the length of time a subscriber has been a subscriber relative to customers that may not have a similar promotional item, determining the effects a specific promotional item has on a subscriber base, or various other activities that may be monitored in association with promotional items. In one form, business system 700 may initiate distribution of a media organizer to only subscribers having a customer service issues such as lost envelopes or damaged or lost digital media. Such subscribers may be monitored by distributed promotional item subscriber monitor 709 to detect any additional occurrences. In this manner, distributed promotional item subscriber monitor 709 may provide information that ma be accessed by strategic promotional output module 708 to target subscribers that may benefit from a specific type of promotional item.

In one embodiment, business system 700 may elect to send a promotional item such as a media organizer to a specific number of new subscribers (e.g. 1000 new subscribers) and monitor activities of the new subscribers having media organizers using distributed promotional item subscriber monitor 709 to determine an impact on other business units or processes of business system 700. For example, one or more effects may be felt within business system 700 including a reduction in the number of service calls for customer service unit 704, a reduction in the number of replacement envelopes or digital media distributed by inventory management and distribution unit 705, a reduction in the number of cancellations thereby effecting a churn rate for a digital media rental company, or various other activities that may be effected. In this manner, business system 700 may quantify an impact of providing a promotional item to subscribers within a digital media rental industry and correlate the activities of the 1000 new subscribers to a larger data set to determine what projected impact for a promotional item allowing a business system 700 to establish metrics to gauge influences that may occur within business system 700 through providing a promotional item offering. As such, a digital media rental company may determine whether to offer a promotional item to all new subscribers or only a subset of new subscribers. A price point for a promotional item may also be determined through analyzing the economic benefits realized through providing a promotional item. In one embodiment, a third party business that may be associated with providing the promotional item may be compensated based on one or more metrics or goals being realized or achieved. For example, if a promotional item reduces a churn rate, reduces customer service calls, etc., a digital media rental company may provide a bonus or other form of compensation to a third party when a metric or goal is achieved.

Business system 700 further includes a referral monitor 710 that monitors and manages referral activities for business system 700. For example, referral monitor 710 may detect when a subscriber is referred from a third party and may provide a referral fee to the third party for each referral provided. In another embodiment, referral monitor 710 monitors referrals that may also originate from a third party offering a promotional item in association with a new subscription. For example, a third party may offer a promotional item to influence a consumer to subscribe to a service. As such, referral monitor 710 may communicate subscription information (i.e. name, address, etc.) to a third party to initiate distribution of a promotional item to the new subscriber. In one embodiment, a current subscriber may refer a new subscriber and referral monitor 710 may credit the current subscriber with the referral providing the current subscriber a referral fee such as a free rental month, a new or used DVD, a fee, reward points or various other promotional items that may be provided in association with a referral.

Business system 700 further includes a subscriber monitor 711 operable to monitor subscriptions and cancellations for business system 700. For example, subscriber monitor 711 may determine increases or decreases in new subscription rates as function of an advertising campaign. In another form, subscriber monitor 711 may monitor subscribers for a specific type of referral program or strategic promotional offering employed by business system 700. Subscriber monitor 711 may also monitor retention rates and subscription intervals for an existing subscriber base relative business activities of business system 700. Business system 700 employing subscriber monitor 711 may monitor a subscriber base and provide an input to business process manager 701 to determine an influences or effects from referral programs, quality assurance programs, call center activities, inventory and distribution activities, marketing activities, strategic promotional item offerings, non-strategic promotional item offerings, or various other business activities that may influence a subscriber base.

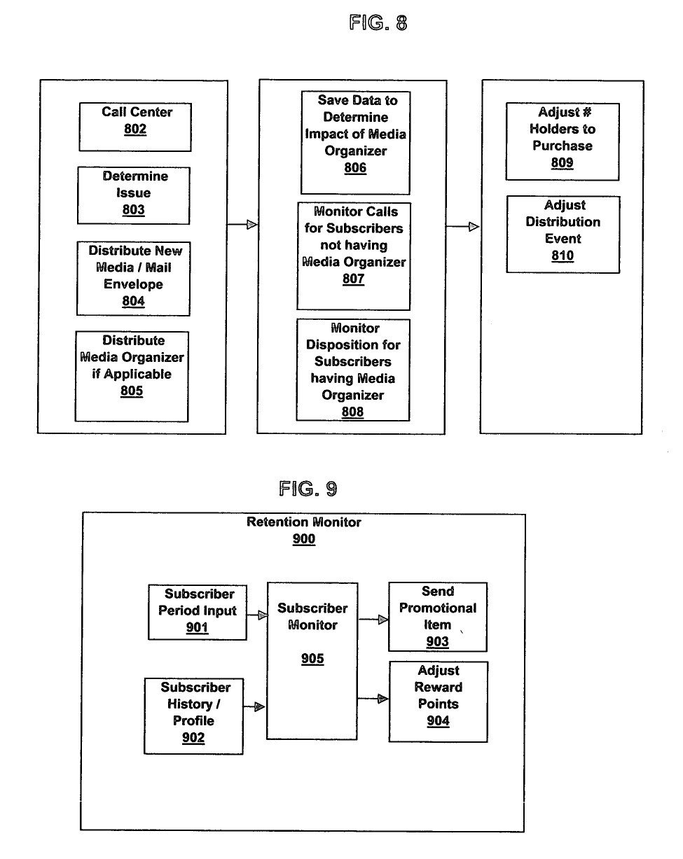

FIG. 8 illustrates a business method for providing and monitoring distribution of promotional items in association with customer service calls according to one aspect of the invention. The method includes monitoring distribution of promotional items distributed in association with a quality assurance event or customer service call. When a current subscriber calls call center 802 with a service issue, call center 802 determines the issue 803 and initiates disposition of the call based on the nature. For example, if a subscriber has lost a return envelope, digital media, or accidentally damaged digital media, call center distributes a new return envelope or digital media 804 to the subscriber. Call center 801 may also initiate distribution of a digital media organizer 805 if a subscriber has lost or damaged an envelope/digital media. Subscriber profile data for the subscriber 806 is updated to indicate that a digital media organizer was mailed to the subscriber. Calls may then be monitored to determine if a call originates from a subscriber not having a media organizer 807.

Disposition of calls may also be monitored to determine if a subscriber having a media organizer calls has any additional issues with handling of digital media or return envelopes. In this manner, a subset of individuals having a digital media organizer may be monitored and compared to all other subscribers not having a digital media organizer to determine if all subscribers should receive a digital media organizer or only those subscribers having an incident with lost or damaged DVDs. For example, a digital media rental company may possess data that may be analyzed to determine if subscribers typical loose more than one envelope or damage more than one video. Data may also be analyzed to determine if the majority of subscribers typically have one or less occurrences. Upon analyzing the data and determining what event will trigger distribution of a media organizer, inventory levels for media holders may be adjusted 809 as needed. Additionally, one or more events may be flagged as trigger events for distributing a media organizer to a subscriber. As stated, a customer service event may trigger distribution of an organizer. However, other events may also trigger distribution of a media organizer including a subscriber renewing, a subscriber referring a new subscriber, a subscriber going for a period of time without any calls to call center 802, a subscriber's birthday or other significant event, or various other events that may be flagged to initiate distribution of a media organizer or other promotional items.

As such, through providing a media organizer to subscribers having issues with lost or damaged envelopes or DVDs, a reduction in customer service calls may be realized. Additionally, the cost for replacing an envelope or DVD is also reduced thereby providing an overall decrease in operational costs for maintaining subscriber bases for a digital media rental company.

FIG. 9 illustrates a business method for providing promotional items in association with a customer retention program according to one aspect of the invention. A customer retention module, illustrated generally at 900, may be employed for retaining an existing subscriber base for a digital media rental company and may be employed at various point in a subscription interval to retain a subscriber. A subscriber period 901 and subscriber history/profile 902 are provided to a subscriber monitor 905 to determine a promotional item 903 to provide to a subscriber. In one form, reward points 904 may be increased based on customer loyalty. Subscriber monitor 905 may use one or more subscriber characteristics or information stored within a subscriber profile may be accessed to determine a promotional item. For example, subscriber-based information may how long a subscriber has been a customer, the number of customer service related incidences a subscriber has had over a given period, the number of referrals a subscriber has provided, the number and type of promotional item(s) a subscriber may have received, whether the subscriber transferred from another media rental company, the average number of movies or games a subscriber watches in a month, the return dates and days for returning digital media. In this manner, a specific promotional may be sent to a subscriber in an effort to retain the subscriber.

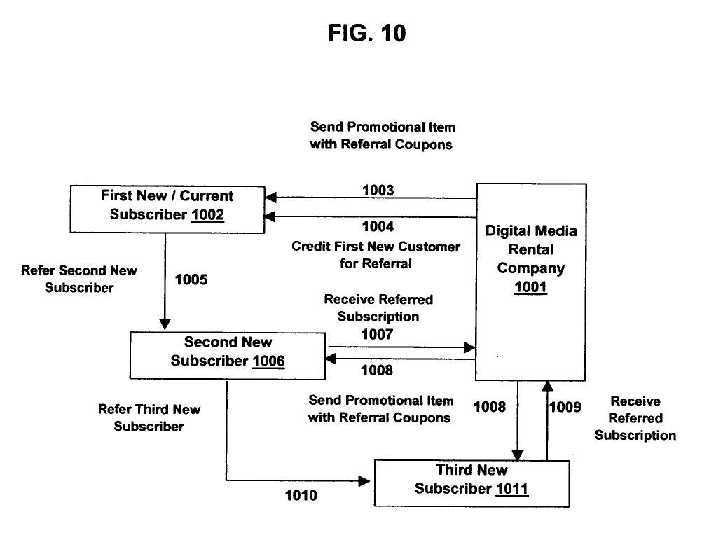

FIG. 10 illustrates a business method for providing a subscriber based referral program using promotional items according to one aspect of the invention. The business method illustrated provides a referral based program using promotional items within a subscriber base. Digital media rental company 1001 receives a new subscription from first new subscriber 1002 or a renewal from first new subscriber 1002 and sends a promotional item with referral coupons 1003 to first new subscriber 1002. In one embodiment, a current subscriber may also receive a promotional item having referral coupons. First new subscriber 1002 refers a second new subscriber 1005 using a referral coupon which includes a reference to first new subscriber 1002. A referral coupon may include providing a referred party a similar promotional item upon digital media rental company receiving a referred subscription 1007. As such, when second new subscriber 1006 subscribes for a service 1007 with digital media rental company 1001, digital media rental company 1001 in turn sends a promotional item with referral coupons to second new subscriber 1006. Additionally, digital media rental company 1001 credits first new subscriber 1002 for the referral of second new subscriber 1006. Second new subscriber 1006 may then refer 1010 third new subscriber 1011 and, upon digital media rental company 1001 receiving a subscription 1009 from third new subscriber 1011, second new subscriber is credited with referring third new subscriber 1011 and digital media rental company 1001 may then send a promotional item with referral coupons 1008 to third new subscriber 1011. In this manner, digital media rental company 1001 may create a tiered referral program through offering promotional items in association with a reward program for growing a subscriber base.

In one embodiment, when third subscriber 1011 subscribes to a service, first subscriber 1002 may also receive credit for third new subscriber 1011 subscribing. For example, digital media rental company 1001 may be providing a free month's subscription for each referral received. As such, both second new subscriber 1006 and first new subscriber 1002 may receive a free rental month. In another embodiment, a referral fee may be paid to each subscriber based on the amount of time each subscriber maintains an uninterrupted subscription. For example, if first new subscriber 1002 subscribes to rental service for a period of less than one year, a 25% referral fee would be paid for every referral made. On the one year anniversary of service, a 50% referral fee would be paid for every referral fee paid provided service has not been interrupted. On a second year anniversary, a 75% referral fee would be paid for every referral. On a third year anniversary, a 100% referral fee would be paid for every referral. Additionally, for every referral that renews their subscription, an annual rebate would be sent to the original referring party. The rebate would be based on each referred customer maintaining a subscription. In this manner, digital media rental company 1001 may provide a referral program structured to maintain a subscriber base through incentivizing current subscribers to maintain a subscription.

Note that although an embodiment of the invention has been shown and described in detail herein, along with certain variants thereof, many other varied embodiments that incorporate the teachings of the invention may be easily constructed by those skilled in the art. Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. Accordingly, the invention is not intended to be limited to the specific form set forth herein, but on the contrary, it is intended to cover such alternatives, modifications, and equivalents, as can be reasonably included within the spirit and scope of the invention.

What is claimed is:

1. A business method comprising the step of:
receiving a request to distribute a promotional item operable to store an order fulfillment article provided in association with a digital media to a digital media subscriber;
determining a delivery mode to deliver the promotional item; and
initiating distribution of the promotional item in association with the digital media to the digital media subscriber.

2. The method of claim 1 further comprising the steps of:
determining if the digital media subscriber is a new subscriber; and
initiating distribution of the promotional item based on a type of new subscription.

3. The method of claim 1 further comprising the steps of:
presenting the promotional item via a web-based subscriber interface in association with soliciting a consumer;
receiving a request to subscribe the consumer; and
distributing the promotional item in response to the consumer subscribing.

4. The method of claim 3, further comprising the steps of:
presenting the promotional item via a web-based interface in association with displaying a web-based subscriber interface; and
enabling a user to purchase the promotional item.

5. The method of claim 3, wherein further comprising the steps of:
communicating a subscription confirmation to a third party; and
providing the third party subscription information for distributing the promotional item.

6. The method of claim 3, further comprising the steps of:
providing a referral advertisement for a digital media subscription;
receiving a request to subscribe in association with the referral advertisement; and
communicating a confirmation of the subscription to the referring site, the confirmation provided in association with distributing the promotional item.

7. The method of claim 1, further comprising the steps of:
confirming the subscription extends beyond a period of time;
providing a referral fee to the originator of the referral; and
distributing the promotional item to the subscriber.

8. The method of claim 1, further comprising the steps of:
providing a referral coupon in association with the distribution of the promotional good, the referral coupon unique to the digital media subscriber;
receiving a request to subscribe a digital media subscription service; and
crediting the referring party with at least a portion of a referral.

9. The method of claim 1, further comprising the steps of:
initiating distribution of a promotional item to a fixed number of new digital media subscribers; and
determining an impact on one or more business characteristics in response to sending the promotional item.

10. The method of claim 1, further comprising the steps of:
determining which current subscribers have lost an order fulfillment article;
initiating distribution of the promotional item to current subscribers; and
determining if a new subscriber should receive the promotional item based on activities of the current subscriber.

11. A business method comprising the steps of:
determining a subscriber characteristic of a digital media subscriber;
determining if a promotional item should be delivered to the digital media subscriber based on the subscriber characteristic; and
distributing the promotional item in association with a subscriber-based deliverable to the digital media subscriber.

12. The method of claim 1 1, further comprising the steps of:
accessing a database to determine a subscriber profile associated with the digital media subscriber;
determining if digital media subscriber meets a criteria; and
distributing the promotional item to the digital media subscriber in response to the criteria.

13. The method of claim 12, further comprising the steps of:
determining a retention rate for a digital media subscriber base;
determining a subscriber rate for the digital subscriber base; and
distributing the promotional item based in response to the retention rate and the subscriber rate.

14. The method of claim 11, further comprising the steps of:
determining if the digital media subscriber is a current digital media subscriber;
determining if the current digital media subscriber has a customer service issue; and
distributing the promotional item based on the customer service issue.

15. The method of claim 14, wherein the customer service issue comprises a lost item issue.

16. The method of claim 14, wherein the customer service issue comprises a damaged item issue.

17. The method of claim 15, further comprising the steps of:
determining if the digital media subscriber is a current digital media subscriber;
determining if the current digital media subscriber should receive the promotional item; and
distributing the promotional item as a customer loyalty reward.

18. The method of claim 11, further comprising the steps of:
determining if the digital media subscriber is a new digital media subscriber;
determining if the subscription includes a trial period; and
distributing the promotional item in association with an expiration date of the trial period.

19. A business method comprising the steps of:
providing a referral advertisement for a digital media subscription;
receiving a request to subscribe in association with the referral advertisement;
receiving a request to distribute a promotional item operable to store a subscriber-based deliverable to a digital media subscriber;
determining a delivery mode to deliver the promotional item;
communicating a confirmation of the subscription to a referring site, the confirmation provided in association with distributing the promotional item; and
distributing the promotional item using the confirmation to the digital media subscriber.

20. The method of claim 19, further comprising the steps of:
subscriber means for receiving a subscription;
referral means for referring a new subscriber to a digital media rental company;
distribution means for initiating distribution of a promotional item to the digital media subscriber; and
payment means for paying a referral fee to a referring party.
